(19) United States
(12) Patent Application Publication
(10) Pub. No.: US 2017/0213221 A1
(43) Pub. Date: Jul. 27, 2017

(54) SYSTEM FOR TRACKING AND VALIDATION OF MULTIPLE INSTANCES OF AN ENTITY IN A PROCESS DATA NETWORK

(71) Applicant: BANK OF AMERICA CORPORATION, Charlotte, NC (US)

(72) Inventors: Manu Jacob Kurian, Dallas, TX (US); Michael Wuehler, New York, NY (US)

(21) Appl. No.: 15/050,098

(22) Filed: Feb. 22, 2016

Related U.S. Application Data
(60) Provisional application No. 62/287,301, filed on Jan. 26, 2016.

(51) Int. Cl. G06Q 20/40; G06Q 20/42

(52) U.S. Cl. CPC G06Q 20/4014; G06Q 20/42

(57) ABSTRACT

Embodiments of the invention are directed to a system, method, or computer program product for generating and using a block chain distributed network for tracking and validating multiple and/or changing identities of an entity and/or individual. The block chain database comprises a distributed ledger that is updated with real-time identification information including end-point identifications of entities and/or individuals. The identifications are monitored and coded with a validity window. The validity window provides a duration of availability for the identification for authorization purposes. Upon an authorization request, the invention identifies an identification associated with the request and confirms the validity window is open for the request prior to authorization.

### CROSS-REFERENCE OF RELATED APPLICATIONS

This application claims priority to U.S. Provisional Patent Application Ser. No. 62/287,301, filed Jan. 26, 2016, entitled “System for Tracking and Validation of Multiple Instances of an Entity in a Process Data Network,” the entirety of which is incorporated herein by reference.

### BACKGROUND

Entities and individuals alike change identification on occasion. With respect to entities, a company may change its name and/or create subsidiary entities in operation. Sometime individuals may change their name upon marriage or the like. After changes in identification entities and individuals are typically required to follow prosecutes for validating the new identification.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for tracking and validating multiple and/or changing identities of an entity or individual via a block chain database.

In some embodiments, the block chain database may identify and store in distributed ledger an identification of an entity or user over time. Each time an identification is used or updated for the same entity or user over time the block chain database adds the new identification to the ledger. In this way, any old identification may be used by an agency to identify a user or entity.

An entity or individual may change names or alias over time and, by using the block chain database, the identification can be validated for purposes of transactions. For example, an entity may have been known as ID 7 in the base but is now ID 8. The system can still honor transactions referencing ID 7. The system may determine a validation window dictating how long an old identification may be considered valid and authorizable by the system. The generated chain of identification may track how an identification of an entity or individual changes over time. Using the block chain database allows for tracking of an entity or individual via a name, alias, or other identification to reorganize and receive resource allocation property by maintaining an ongoing record of end-points for the received resource allocations. This tracks transactions such as payments and the like back to the actual entity or individual rather than a trade name, third party proxy, outdated name, alias, or the like.

Embodiments of the invention relate to systems, methods, and computer program products for tracking and validating multiple instance of a user, the invention comprising: receiving an end-point identification for the user at one or more nodes of the block chain distributed network; updating a distributed ledger with the end-point identification via transmission of data from the one or more nodes to the distributed ledger associated with the block chain distributed network; receiving one or more identifications for the user at the one or more nodes of the block chain distributed network, wherein the received one or more identifications are tracked and time stamped at each identification use; linking the one or more identifications for the user to the end-point identification to generate an ongoing record of user identifications; creating a validity window for each of the one or more identifications for the user, wherein the validity window is a time frame after the last identification use that each of the one or more identifications are valid for identity authorization for the user; receiving a transaction record comprising one of the one or more identifications for the user; confirming the one of the one or more identifications for the user is received within the validity window for the one of the one or more identifications; and communicating the confirmation and the end-point identification associated with the user of the one of the one or more identifications.

In some embodiments, the invention further comprises confirming the one of the one or more identifications for the user is not within the validity window for the one of the one or more identifications; and communicating, via a communication like with a user device, to the user the confirmation, wherein the communication allows the user to present an alternative identification for a transaction.

In some embodiments, the one or more nodes of the block chain distributed network is integrated into a third party system and coded to identify and transmit to the distributed ledger the one or more identifications used by the user for identity authorization for a transaction.

In some embodiments, the end-point identification comprises a tax identification, social security identification, or name given at an inception of the user. In some embodiments, the end-point identification has an unlimited duration validity window. In some embodiments, a duration of the validity window time frame is generated based on a type of identification being used, a duration of time the identification being used has been in existence, and required steps for user manipulation of the identification.

In some embodiments, the user is an individual or an entity and the one or more identifications of the user further comprise a trade name, alias, internet handle, or username associated with the user.

In some embodiments, receiving the transaction record comprising one of the one or more identifications for the user further comprises matching the received one of the one or more identifications to a previously stored one or more identifications in the distributed ledger.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a block chain identification system environment, in accordance with one embodiment of the present invention;

FIG. 2A provides centralized database architecture environment, in accordance with one embodiment of the present invention;

FIG. 2B provides a block chain system environment architecture, in accordance with one embodiment of the present invention;

FIG. 3 provides a high level process flow illustrating a block chain user identification process, in accordance with one embodiment of the present invention;

FIG. 4 provides a process map illustrating validation window generation process, in accordance with one embodiment of the present invention;

FIG. 5 provides a process map illustrating the utilization of a prior identification for transaction authentication, in accordance with one embodiment of the present invention; and

FIG. 6 provides a process map illustrating the authorization of an identification for transaction authentication, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to an entity or individual that may have one or more identifications associated with the entity or individual. In some embodiments, identities of an entity may include trade names, third party proxy, outdated names, online handles, aliases, subsidiary companies, or the like. In some embodiments, identities of an individual may include online handles, usernames, aliases, family names, maiden names, nicknames, or the like. For purposes of this invention, the term “user” and “user” may be used interchangeably.

Furthermore, as used herein the term “user device” or “mobile device” may refer to mobile phones, personal computing devices, tablet computers, wearable devices, and/or any portable electronic device capable of receiving and/or storing data therein.

An “account” is the relationship that a user has with an entity or another entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. “Resources” include accounts of the user and/or other property owned by the user. The resources may be associated with accounts or may be property that is not associated with a specific account. Examples of resources associated with accounts may be accounts that have cash or cash equivalents, or accounts that are funded with or contain property, such as safety despots box account that jewelry, a trust account that is funded with property, or the like. Examples of resources that may not be associated with accounts may be antiques in a user's home, jewelry in a user's home, or the like. “Funds” or “Available Balance” are a balance in an account that can be invested or withdrawn. For example, the funds may refer to a bank ledger balance minus the amount of any monetary checks in the process of collection. Funds may also be referred to as an available balance, a collected balance, good funds, and usable funds.

A “transaction” or “resource distribution” refers to any communication between a user and the financial institution or other entity monitoring the user's activities. Alternatively, in some embodiments, the term “transaction” may be used when describing the block chain database as a transaction type of record. The transaction type records consists of the actual data stored in the block chain. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

Embodiments of the present invention address the above needs and/or achieve other advantages by providing apparatuses (e.g., a system, computer program product and/or other devices) and methods for operatively connecting with a block chain distributed network and using the block chain distributed network for facilitating identification of a user for transaction completion.

In some embodiments, the block chain database may identify and store in distributed ledger an identification of an entity or user over time. Each time an identification is used or updated for the same entity or user over time the block chain database adds the new identification to the ledger. In this way, any old identification may be used by an entity to identify a user. A user may change names or alias over time and, by using the block chain database, the identification can be validated for purposes of transactions. For example, a user may have been known as ID 7 in the base but is now ID 8. The system can still honor transactions referencing ID 7. The system may determine a validation window dictating how long an old identification may be considered valid and authorizable by the system. The generated chain of identification may track how an identification of the user changes over time. Using the block chain database allows for tracking of the user via a name, alias, or other identification to reorganize and receive resource allocation property by maintaining an ongoing record of end-points for the received resource allocations. This tracks transactions such as payments and the like back to the actual user rather than a trade name, third party proxy, outdated name, alias, or the like.

Embodiments of the invention are directed to a system, method, or computer program product for a distributive network system with specialized data feeds associated with the distributive network and specific triggering events associated with the data feeds for user identification. Thus, the system may communicate with, store, and execute code for real-time identification via a block chain database architecture.

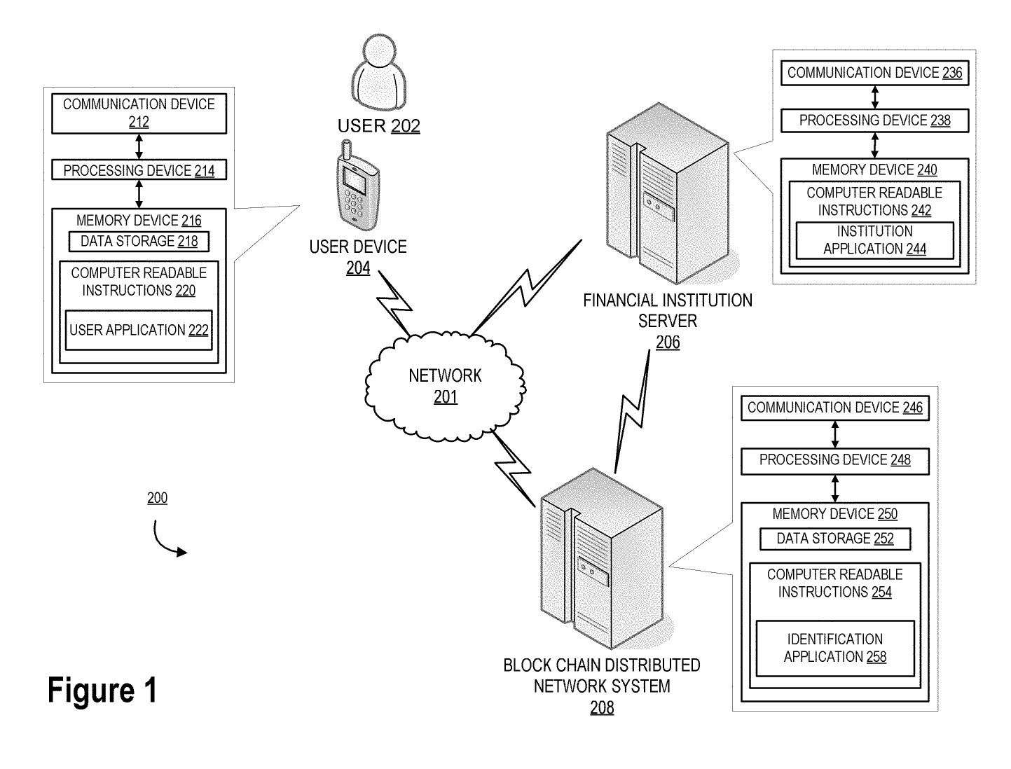

FIG. 1 illustrates block chain identification system environment 200, in accordance with one embodiment of the present invention. FIG. 1 provides the system environment 200 for which the distributive network system with specialized data feeds associated with the block chain instrument conversion.

FIG. 1 provides a unique system that includes specialized servers and system communicably linked across a distributive network of nodes required to perform the functions of user identification.

As illustrated in FIG. 1, the block chain distributed network system 208 is operatively coupled, via a network 201 to the user device 204, and to the financial institution server 206. In this way, the block chain distributed network system 208 can send information to and receive information from the user device 204 and the financial institution server 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that has had or does have one or more identities. In other embodiments, the user 202 is an entity that has had or does have one or more identities, subsidiaries, or the like. In some embodiments, the user 202 has a user device, such as a mobile phone, tablet, computer, or the like. FIG. 1 also illustrates a user device 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the financial institution server 206 and the block chain distributed network system 208. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to complete a transaction.

As further illustrated in FIG. 1, the block chain distributed network system 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the financial institution server 206 and the user device 204. As such, the communication device 246 generally comprises a modem, server, or other device for communicating with other devices on the network 201.

As further illustrated in FIG. 1, the block chain distributed network system 208 comprises computer-readable instructions 254 stored in the memory device 250, which in one embodiment includes the computer-readable instructions 254 of an identification application 258. In some embodiments, the memory device 250 includes data storage 252 for storing data related to the system environment, but not limited to data created and/or used by the identification application 258.

Embodiments of the block chain distributed network system 208 may include multiple systems, servers, computers or the like maintained by one or many entities. FIG. 1 merely illustrates one of those systems that, typically, interacts with many other similar systems to form the block chain. In one embodiment of the invention, the block chain distributed network system 208 is operated by a second entity that is a different or separate entity from the financial institution server 206. In some embodiments, the financial institution server 206 may be part of the block chain. Similarly, in some embodiments, the block chain distributed network system 208 is part of the financial institution server 206. In other embodiments, the financial institution server 206 is distinct from the block chain distributed network system 208.

In one embodiment of the block chain distributed network system 208 the memory device 250 stores, but is not limited to, an identification application 258 and a distributed ledger. In some embodiments, the distributed ledger stores data including, but not limited to, smart identification logic and rules, user identifications, user legal identifications, associated logic and rules, and the like. In one embodiment of the invention, both the identification application 258 and the distributed ledger may associate with applications having computer-executable program code that instructs the processing device 248 to operate the network communication device 246 to perform certain communication functions involving described herein. In one embodiment, the computer-executable program code of an application associated with the distributed ledger and identification application 258 may also instruct the processing device 248 to perform certain logic, data processing, and data storing functions of the application.

The processing device 248 is configured to use the communication device 246 to gather data, such as data corresponding to transactions, blocks or other updates to the distributed ledger from various data sources such as other block chain network system. The processing device 248 stores the data that it receives in its copy of the distributed ledger stored in the memory device 250.

In the embodiment illustrated in FIG. 1 and described throughout much of this specification, the identification application 258 may integrate nodes of the generated block chain database into various systems, determine end-point identifications of the users as end-points, link subsequent identifications for identification chain, generate validity windows, and provide authorization for transactions using identification.

In some embodiments, the identification application 258 may integrate nodes of the generated block chain database into various systems. In some embodiments, the identification application 258 may generate a block chain database specifically for identification authentication for transaction completion that connects with user systems, merchant systems, financial institution systems, internet systems management systems, and/or management entities to generate a block chain database with information about user identifications used in the past and currently being used. In this way, the user identities may be one or more of aliases, third party proxies, trade names, maiden names, internet handles, usernames, code names, nick names, or the like that may be associated a user. In other embodiments, the identification application 258 may piggy back off of an existing block chain database and code the database for identification authentication for transaction completion.

The block chain database generated is a decentralized block chain configuration that ensures accurate mapping of real-time user identifications that the user may be using and/or used in the past. Accordingly, a block chain configuration may be used to maintain an accurate ledger of identities and to provide validation of identifications for authorizing transactions. The generated block chain database maintains a list of data records, such as real-time and on-going list of identities associated with a user. Furthermore, the block chain database may also maintain rules associated with validity windows. Validity windows include rules that determine a duration of time that the identification is valid for authentication of a transaction. The security of which is enhanced by the distributed nature of the block chain. A block chain typically includes several nodes, which may be one or more systems, machines, computers, databases, data stores or the like operably connected with one another.

Furthermore, the identification application 258 may integrate and provide nodes of the block chain distributed database into various systems. In this way, the identification application 258 may code nodes for integration into one or more user systems, merchant systems, financial institution systems, internet systems management systems, and/or management entities. In some embodiments, the identification application 258 may generate nodes that are independent of the systems. As such, the nodes may be separate devices and be coded for recognizing user identifications.

In some embodiments, the identification application 258 may determine end-point identifications of the users as end-points. In some embodiments, the initial identification may be the end-point identification such as an original legal name, an initial corporate name registered with a state or county, given birth name, social security number, tax identification number, or the like. The identification application 258 may determine the initial identification by identifying one or more user identifications from the one or more nodes of the block chain database. In this way, users, identification issuers, financial institutions, merchants, entities, or the like may provide identification information to the identification application 258 in real-time, such that a real-time identification information of a user 202 is provided in an ongoing record of a user 202 into a distributed ledger in the block chain database. The identification application 258 may determine the initial identification based on the type of identification received. In some embodiments, several identifications may be received by the identification application 258 prior to receiving the initial identification. In other embodiments, the identification application 258 may receive the initial identification first. The identification application 258 may determine the initial identification by identifying an age of the identification, a type of identification, or the like.

Once the initial identification of the user is determined, the identification application 258 may store the determined end-point identification in the block chain database distributed ledger. The storage may indicate that the identification is the end-point identification in the distributed ledger and allow for ongoing records to be built off of the end-point of the identification.

In some embodiments, the identification application 258 may link subsequent identifications for identification chain. As such, the identification application 258 via nodes may identify subsequent identifications associated with the user 202. The subsequent identifications may be received from various nodes associated with the identification application 258. The identifications may be time and date stamped upon receiving of the identification at the various nodes. These subsequent identifications may be linked the end-point identification in the distributed ledger for the ongoing record of identifications of a user 202.

In some embodiments, the identification application 258 generate validity windows. The identification application 258 stores a chain of identifications from an original name, to trade names, to internet handles, to aliases, or the like are linked together based on time stamp in the distributed ledger. As such, based on the time stamp the identification application 258 may be able to track a duration of time the identification has been in use. Furthermore, the identification application 258 may also track the last time the user used the identification for transaction authorization. This information may be utilized to generate a validity window. The validity window is a window of time after the last time the user utilized the identification for a transaction authorization that the identification application 258 will allow the user to attempt to use the identification again for authorization. The validity window is time frame is dependent on the type of identification being used. The end-point identification may have no window and be available for use at any time in the future. While internet handles or aliases may have a limited window of a week or a month of time.

In some embodiments, the identification application 258 provide authorization for transactions using a user presented previous identification. As such, the identification application 258 may receive an indication that a transaction is attempting to be performed between the user 202 and a third party. The identification application 258 may receive the identification of the user 202 presented during that transaction. The identification application 258 may review the identification presented and compare it to the distributed ledger. The identification application 258 determines if the identification presented matches an identification in the distributed ledger and if the identification presented is within a validity window. In some embodiments, when the identification application 258 determines that the identification presented matches and it is within the validity window the identification application 258 may allow the transaction to be completed using the presented identification that is chained in the distributed ledger that is in the validity window. As such, the user 202 may be able to utilize an outdated identification for completion of a transaction.

As illustrated in FIG. 1, the financial institution server 206 is connected to the block chain distributed network system 208 and is associated with a financial institution network. In this way, while only one financial institution server 206 is illustrated in FIG. 1, it is understood that multiple network systems may make up the system environment 200. The financial institution server 206 generally comprises a communication device 236, a processing device 238, and a memory device 240. The financial institution server 206 comprises computer-readable instructions 242 stored in the memory device 240, which in one embodiment includes the computer-readable instructions 242 of an institution application 244. The financial institution server 206 may communicate with the block chain distributed network system 208 to provide real-time resource availability for a user account. While the block chain distributed network system 208 may communicate with the financial institution server 206 via a secure connection generated for secure encrypted communications between the two systems for communicating a resource commitment for an non-secure instrument such that resources are allocated for the non-secure instrument and are not available for subsequent use.

It is understood that the servers, systems, and devices described herein illustrate one embodiment of the invention. It is further understood that one or more of the servers, systems, and devices can be combined in other embodiments and still function in the same or similar way as the embodiments described herein.

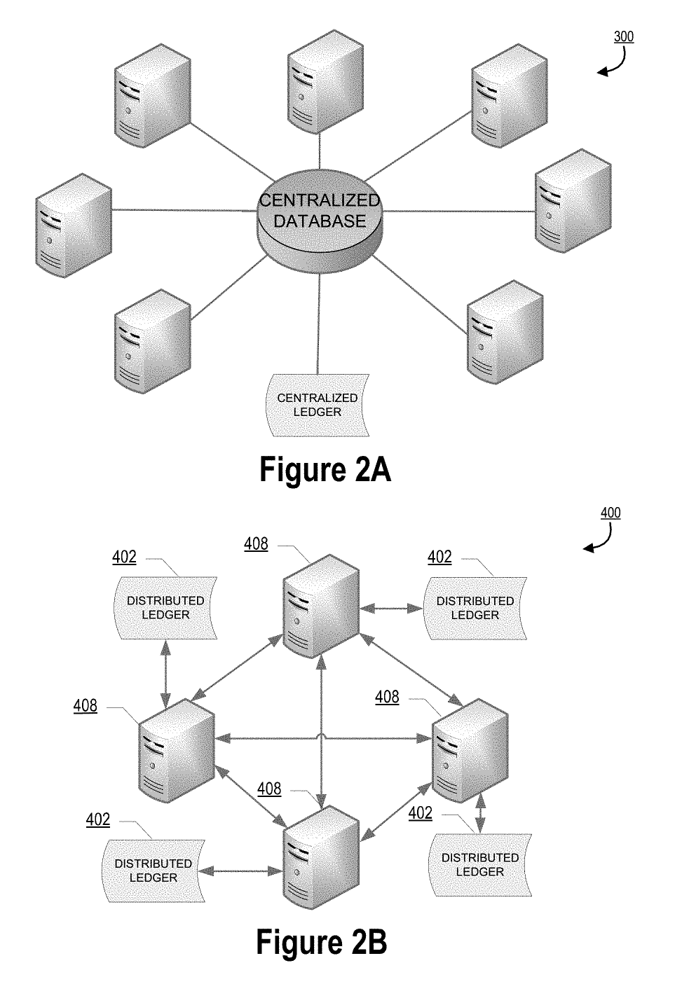

FIG. 2A illustrates a centralized database architecture environment 300, in accordance with one embodiment of the present invention. The centralized database architecture comprises multiple nodes from one or more sources and converge into a centralized database. The system, in this embodiment, may generate a single centralized ledger for data received from the various nodes.

FIG. 2B provides a block chain system environment architecture 400, in accordance with one embodiment of the present invention. Rather than utilizing a centralized database of data for instrument conversion, as discussed above in FIG. 2A, various embodiments of the invention may use a decentralized block chain configuration or architecture as shown in FIG. 2B in order to facilitate the converting of an instrument from a non-secured format to a secured format. Such a decentralized block chain configuration ensures accurate mapping of user identifications. Accordingly, a block chain configuration may be used to maintain an accurate ledger of various identifications used for transaction completion by a user. For example, a user may be created and register the business under ID1. Over the years, the user may have one or more subsidiary companies under ID2 and ID3, have an online handle of ID4, and have a trade name ID5. The block chain database may identify each name associated with the user from one or more of the multiple nodes 408 of the block chain 400. Each time an identification is recognized by a node 408, the system may identify the user associated with that identification and store the added identification with the user in a distributed ledger 402. As such, when the user is attempting to complete a transaction, the user may use ID1, ID2, ID3, ID4, or ID5 to complete the transaction. The system will recognized each identification as being associated with the user and the user's legal name. As such, additional authorization is not needed to authenticate the user to complete the transaction using one of the different identifications.

A block chain or blockchain is a distributed database that maintains a list of data records, such as real-time identifications associated with one or more users, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data records recorded in the block chain are enforced cryptoraphically and stored on the nodes of the block chain.

A block chain provides numerous advantages over traditional databases. A large number of nodes of a block chain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the block chain that creates a transaction can determine within a level of certainty whether the transaction can take place and become final by confirming that no conflicting transactions (i.e., the same currency unit has not already been spent) confirmed by the block chain elsewhere.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria. In some block chain systems, miners are incentivized to create blocks by a rewards structure that offers a pre-defined per-block reward and/or fees offered within the transactions validated themselves. Thus, when a miner successfully validates a transaction on the block chain, the miner may receive rewards or the like as an incentive to continue creating new blocks. In some embodiments, transactions type records comprise various identifications for users.

As mentioned above and referring to FIG. 2B, a block chain system 400 is typically decentralized—meaning that a distributed ledger 402 (i.e., a decentralized ledger) is maintained on multiple nodes 408 of the block chain 400. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains.

In some embodiments the block chain distributed network nodes 408 while part of the block chain disturbed network system 208 may be integrated into or associated with a financial institution system, a merchant system, a user system, or the like. In this way, when the block chain distributed network nodes 408 is integrated into a channel, the block chain distributed network nodes 408 may identify identifications used by the user and provide the real-time identification updates to the ledger. Furthermore, the block chain distributed network nodes 408 may be coded for identification of user identification updates. Thus, once integrated into the channel the block chain distributed network nodes 408 may identify changes or updates in identifications and provide the same to the distributed ledger for updating.

Various other specific-purpose implementations of block chains have been developed. These include distributed domain name management, decentralized crowd-funding, synchronous/asynchronous communication, decentralized real-time ride sharing and even a general purpose deployment of decentralized applications. The block chain 400 may perform one or more of the steps or functions performed by the block chain distributed network system as discussed above with reference to FIG. 1.

In various embodiments of the invention, a block chain implementation is used to identify various identification of a user for transaction completion authorization. For real-time identification and authentication purposes, multiple active directories may be created. In such cases, a need exists to ensure mappings are not overloaded or redirected and in order to maintain a complete audit trail. The block chain configuration is used to index accounts and resources via mappings in all directories and maintain a full and visible audit trail. Mining is used, in some embodiments, to ensure that changes to specific mappings (e.g., mapping an alias identification to a financial institution and/or mapping user legal names to identifications) are confirmed and/or have reached a predetermined level of consensus. This also ensures unauthorized users are not manipulating the directories.

Identifications of users are mapped to the appropriate user for subsequent transaction completion via any user identification. This information must be universally available to everyone on the network, and the block chain configuration enables such information distribution. In some embodiments of the invention, such a mapping, while integral to clearing (or validating) the transaction, the mapping of the identification to an account is maintained as private information. For example, the mapping may be maintained at a server local to the financial institution. Thus, once a requested transaction has been placed on the public block chain, the block chain network recognizes that the identification associated with the transaction is mapped to a particular user and user account. That financial institution's server or system connected to the block chain receives the information about the user and user authentication and can validate that the transaction may be validated by looking up the appropriate mapping of the user identification. As noted, this information is not placed on the public block chain, but rather is held privately, such as on a private block chain or a “side-chain”.

One advantage of using a block chain configuration for real-time user identification is the expedited transaction completion and an opportunity for scaling. Thousands of financial institutions, merchants, and/or users may participate in a block chain real-time user identification and, therefore, the time to validation of an identification to a user may be shortened.

For example, a proposed transaction that is placed on the block chain may be validated by one or a predetermined number of nodes of the block chain in order for the transaction to proceed. The nodes may work as miners or “validators” in order to confirm the identification of a user for authorization of the transaction and is mapped to a particular, valid financial institution. This determination may be based on the fact that the financial institution that originally mapped the instrument to itself (the “originating FI”) has placed it on the block chain and in some cases, has included additional information such as a key that validates the instrument.

The block chain may be configured with a set of rules to dictate the validation of previously used identifications and validate the user for an authentication. In some embodiments, the rules dictate that the originating FI must approve all transactions for instruments mapped to that FI. In some embodiments, the rules dictate that some or all transactions may be approved by one or more validator nodes without further input from the originating FI other than the validation of the mapped instrument and resources. In some such cases, the rules dictate that the mapped instrument, when placed on the block chain also includes additional information that is useful in determining whether an identification presented by the user is authorized for completion of a transaction.

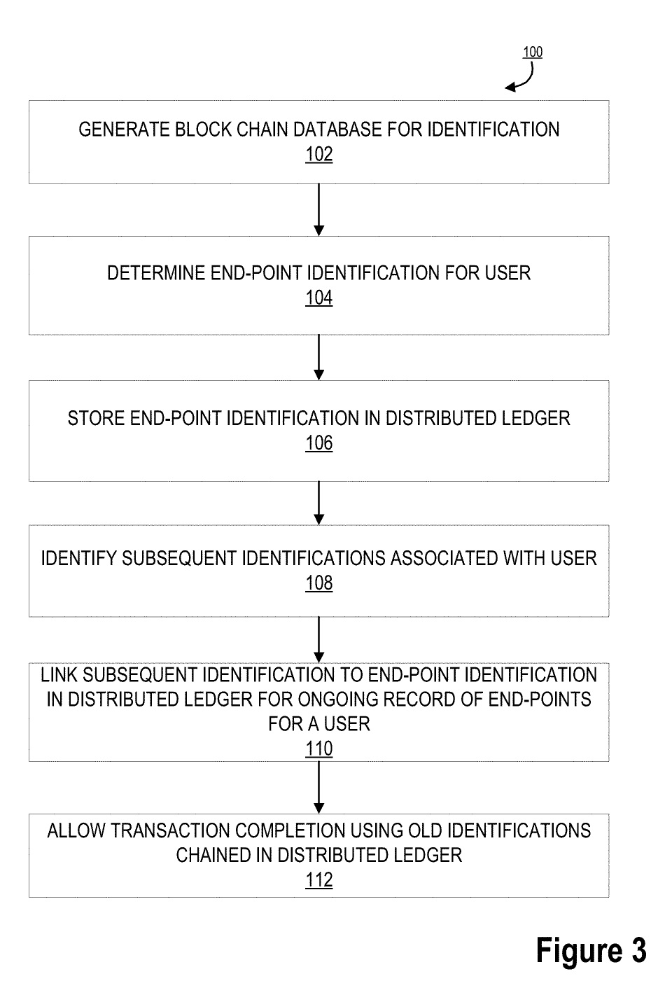

FIG. 3 provides a high level process flow illustrating a block chain user identification process 100, in accordance with one embodiment of the present invention. As illustrated in block 102, the process 100 is initiated by generating a block chain database for identification. In this way, the system generates a block chain database that connects with user systems, merchant systems, financial institution systems, internet systems management systems, and/or management entities to generate a block chain database with information about user identifications used in the past and currently being used. In this way, the user identities may be one or more of aliases, third party proxies, trade names, maiden names, internet handles, usernames, code names, nick names, or the like that may be associated a user.

The block chain database generated is a decentralized block chain configuration that ensures accurate mapping of real-time user identifications that the user may be using and/or used in the past. Accordingly, a block chain configuration may be used to maintain an accurate ledger of identities and to provide validation of identifications for authorizing transactions. The generated block chain database maintains a list of data records, such as real-time and on-going list of identities associated with a user. Furthermore, the block chain database may also maintain rules associated with validity windows. Validity windows include rules that determine a duration of time that the identification is valid for authentication of a transaction. The security of which is enhanced by the distributed nature of the block chain. A block chain typically includes several nodes, which may be one or more systems, machines, computers, databases, data stores or the like operably connected with one another.

Next, as illustrated in block 104 the process 100 continues by determining the end-point identification of the user. In some embodiments, the end-point identification may be an original legal name, such as an initial corporate name registered with a state or county, given birth name, social security number, tax identification number, or the like. Determining the end-point identification may be performed by identifying one or more user identifications from the one or more nodes of the block chain database. In this way, users, identification issuers, financial institutions, merchants, entities, or the like may provide identification information to the block chain database in real-time, such that a real-time identification information of a user is provided in an ongoing record of a user into a distributed ledger in the block chain database. The system may determine the end-point identification based on the type of identification received. In some embodiments, several identifications may be received by the system prior to receiving the end-point identification. In other embodiments, the system may receive the end-point identification first. The system may determine the end-point identification by identifying an age of the identification, a type of identification, or the like.

As illustrated in block 106, once the end-point identification of the user is determined, the process 100 continues by storing the determined end-point identification in the block chain database distributed ledger. The storage may indicate that the identification is the end-point identification in the distributed ledger and allow for ongoing records to be built off of the end-point of the end-point identification.

As illustrated in block 108, the process 100 continues to identify subsequent identifications associated with the user. The subsequent identifications may be received from various nodes associated with the block chain database. The identifications may be time and date stamped upon receiving of the identification at the various nodes associated with the block chain database. Next, as illustrated in block 110, the process 100 continues by linking the subsequent identifications identified from block 108 to the end-point identification in the distributed ledger for the ongoing record of end-points for a user. In this way, a chain of identifications from an original name, to trade names, to internet handles, to aliases, or the like are linked together based on time stamp in the distributed ledger. As such, based on the time stamp the system may be able to track a duration of time the identification has been in use. Furthermore, the system may also track the last time the user used the identification for transaction authorization. This information may be utilized to generate a validity window. The validity window is a window of time after the last time the user utilized the identification for a transaction authorization that the system will allow the user to attempt to use the identification again for authorization. The validity window is time frame is dependent on the type of identification being used. The end-point identification may have no window and be available for use at any time in the future. While internet handles or aliases may have a limited window of a week or a month of time.

Next, as illustrated in block 112, the process 100 completes by allowing a transaction to be completed using an old identification that is chained in the distributed ledger that is in the validity window for the respected identification. As such, the user may be able to utilize an outdated identification for completion of a transaction.

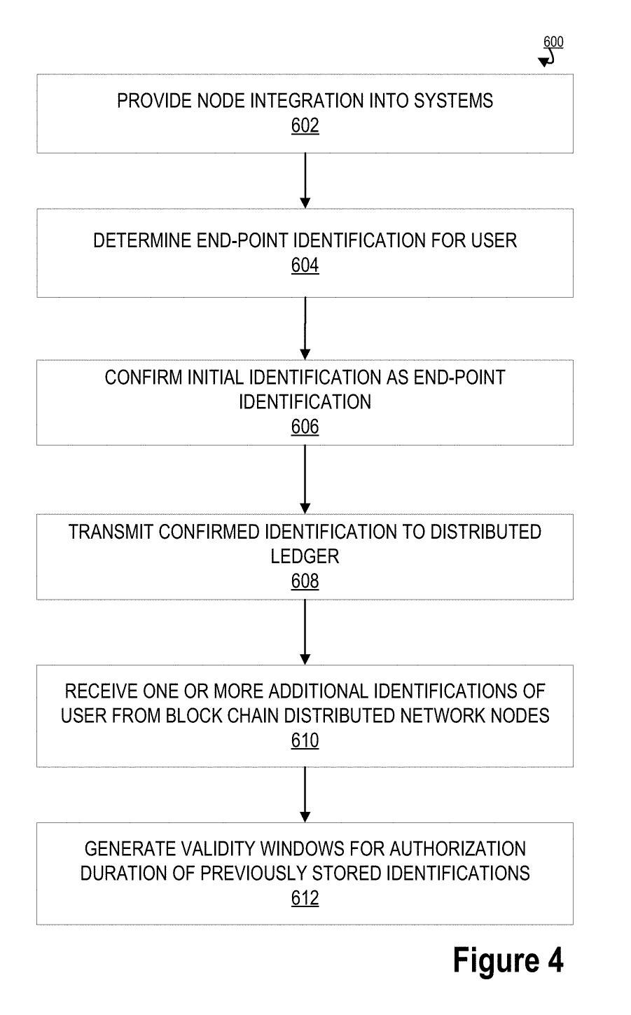

FIG. 4 illustrates process map for validation window generation process 600, in accordance with one embodiment of the present invention. The process 600 uses the generated block chain database for identification tracking and validation. In some embodiments, the invention may generate the block chain database for the identification tracking and validation. In other embodiments, the invention may code a current block chain database for the identification tracking and validation.

As illustrated in block 602, the process 600 is initiated by providing nodes of the block chain distributed database integration into various systems. In some embodiments, nodes may be independent of systems such as merchants, financial institutions, users, or the like. In other embodiments, the nodes may be coded for recognizing user identifications and be integrated into the various systems.

Next, as illustrated in block 604, the process continues by determining the end-point identification for the user. In some embodiments, the end-point identification may be an original legal name, such as an initial corporate name registered with a state or county, given birth name, social security number, tax identification number, or the like. Determining the end-point identification may be performed by identifying one or more user identifications from the integration of the one or more nodes of the block chain database. In this way, users, identification issuers, financial institutions, merchants, entities, or the like may provide identification information to the block chain database in real-time, such that a real-time identification information of a user is provided in an ongoing record of a user into a distributed ledger in the block chain database.

Next, as illustrated in block 606, the process 600 continues by confirming the initial identification as an original end-point identification for the user. As such, the distributed ledger may determine the end-point identification based on the type of identification received. The system may determine the end-point identification by identifying an age of the identification, a type of identification, or the like. In this way, the original and/or legal identification may be identified based on an age of the identification relative to the user, whether the identification is a legal identification such as a registered tax identification, social security number, or the like. In some embodiments, the user, a financial institution, entity, or the like may provide the end-point identification of the user. The system may determine a confidence rating for the identification based on the age or type of identification received, the confidence rating rates the confidence that the system has with the identification being the end-point identification for the user. As illustrated in block 608, the process continues after confirming the end-point identification, by transmitting the confirmed identification to the distributed ledger of the block chain database. As such an end-point is created for a user identification. The end-point is the original and/or end-point identification that is used to build from for the user.

As illustrated in block 610, the process 600 continues by receiving one or more additional identifications of the user from block chain distributed network nodes. In some embodiments, the system may integrate one or more nodes into other systems such as financial institution systems, merchant systems, entity systems, user systems, third party systems, and/or the like. As such, upon use of an additional identifications by the user for transactions, the system may identify and extract those additional identification and store those additional identifications in connection with the original identification for the user. In this way, the distributed ledger may store the additional identifications in a chain, storing the user identifications.

As illustrated in block 612, the process 600 is terminated by generating one or more validity windows for authorization duration of stored identifications. The validity window is a window of time after the last time the user utilized the identification for a transaction authorization that the system will allow the user to attempt to use the identification again for authorization. The validity window is time frame is dependent on the type of identification being used. The end-point identification may have no window and be available for use at any time in the future. While internet handles or aliases may have a limited window of a week or a month of time. The block chain database may also maintain rules associated with validity windows. The security of which is enhanced by the distributed nature of the block chain.

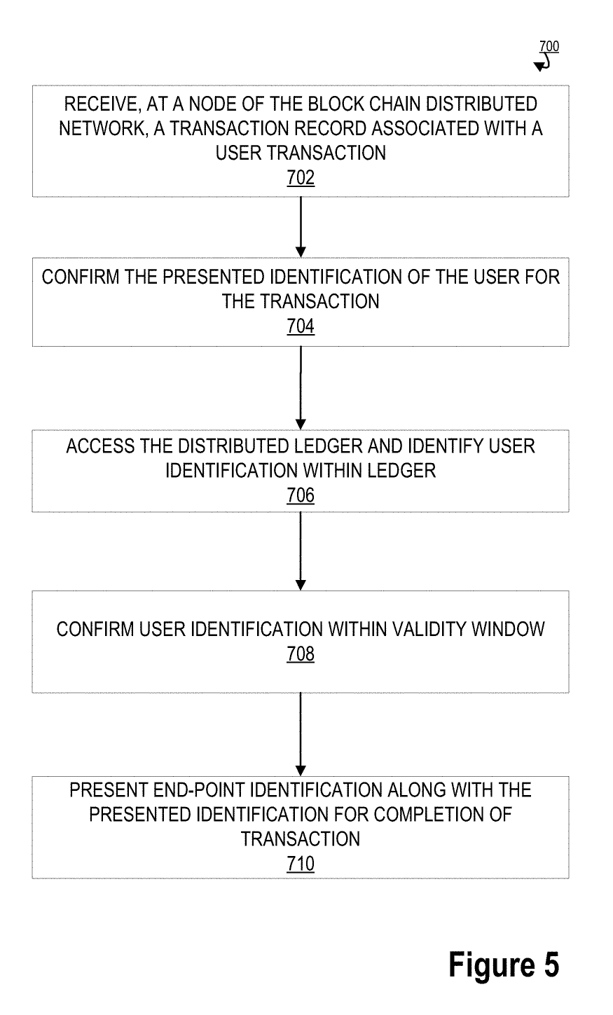

FIG. 5 illustrates a process map for the utilization of a prior identification for transaction authentication 700, in accordance with one embodiment of the present invention. As illustrated in block 702, the process 700 is initiated by receiving, at a node of the block chain distributed network, a transaction record associated with a user transaction. The transaction record may be provided prior to completion of the transaction, such that the system may authorize the identity of the user. The transaction record may include the identification presented, a transaction type, a third party associated with the transaction, and/or the like. In some embodiments, the user may provide user identification. In other embodiments, the other party of the transaction may provide the user identification. As illustrated in block 704, the system confirms the presented identification for the user for the transaction with one or more parties of the transaction.

Once the identification of the user is received via the transaction record, the system may access and search for the identification in the distributed ledger associated with the block chain, as illustrated in block 706. Searching of the distributed ledger may include one or more partial or positive matches to the identification presented. Based on the transaction record, the system may identify the identification presented within the block chain database distributed ledger. The system may confirm that the presented identification for the transaction is one correlated with the user in the distributed ledger.

Next, as illustrated in block 708, once the system confirms that the presented identification is a match to a user identification in the distributed ledger, the process 700 continues by confirming that the user identification is within the validity window. The validity window is a window of time after the last time the user utilized the identification for a transaction authorization that the system will allow the user to attempt to use the identification again for authorization. The validity window is time frame is dependent on the type of identification being used. The initial identification may have no window and be available for use at any time in the future. While internet handles or aliases may have a limited window of a week or a month of time.

Once the system identifies that the presented identification is associated with the user and within the validity window, the process 700 continues by presenting the end-point identification along with the presented identification for completion of the transaction, as illustrated in block 710. In this way, the transaction may be completed using the end-point identification to maintain consistency and expedite the transaction completion process. The system may provide the identifications to the user, other parties of the transaction, financial institutions, or the like.

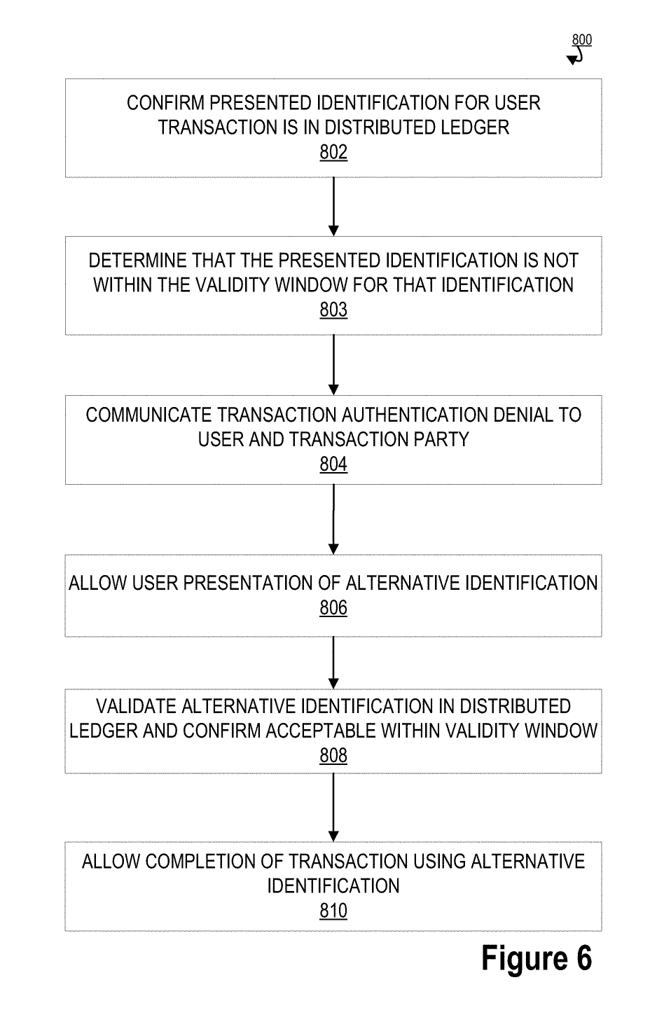

FIG. 6 illustrates a process map for the authorization of an identification for transaction authentication 800, in accordance with one embodiment of the present invention. As illustrated in block 802, the process 800 is initiated by confirming that the presented identification for the user for the transaction is in the distributed ledger. In this way, the presented identification may match an identification of the user already presented and known in the distributed ledger.

The process 800 continues by reviewing the matched presented identification to the validity window that is specific for that identification. In this way, different identifications have different validity window rules generated. A birth or original corporate name may have a longer validity window than an alias and/or internet handle. The validity windows are determined based on determinations of durations of standard types of identifications. Furthermore, the validity windows are then adjusted based on the duration of time since the last time the user has utilized the identification. As such, if there has been no activity for a month and/or year for the specific identification, it may be out of the validity window for that identification. As illustrated in block 803, the system determines that the presented identification is not within the validity window for that identification. As such, the presented identification for the user falls outside the validity window for the identification, thus it does not qualify as an identification that is capable of being authenticated for transaction completion.

Next, as illustrated in block 804, the process 800 continues by communicating the transaction authentication denial to the user and the other parties of the transaction. As such, but the user and the other parties are aware that the identification is not satisfactory to authenticate the completion of the transaction. Furthermore, the system may provide the user with the ability to present alternative identification as illustrated in block 806. In this way, the user may be able to provide a more recent or valid within the validity window identification prior to completion of the transaction. In some embodiments, the system may provide via an interface or the like a means for presenting an alternative identification via the user device.

As illustrated in block 808, once the user provides an alternative identification the system may validate the alternative identification in the distributed ledger and confirm acceptability of the identification as being within the validity window. Finally, as illustrated in block 810, the process 800 is completed by allowing the completion of the transaction using the alternative identification for authorization.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent | | |
|---|---|---|---|
| | Application | | |
| Docket Number | Ser. No. | Title | Filed On |
| 6823US1.014033.2555 | 14/942,326 | TRANSPARENT SELF- | Nov. 16, 2015 |
| | | MANAGING REWARDS | |
| | | PROGRAM USING | |
| | | BLOCKCHAIN AND | |
| | | SMART CONTRACTS | |
| 6908US1.014033.2652 | 15/041,555 | BLOCK CHAIN ALIAS | Feb. 11, 2016 |
| | | FOR PERSON-TO-PERSON | |
| | | PAYMENTS | |
| 6908USP1.014033.2556 | 62/253,935 | BLOCK CHAIN ALIAS | Nov. 11, 2015 |
| | | PERSON-TO-PERSON | |
| | | PAYMENT | |
| 6985US1.014033.2605 | 15/041,566 | BLOCK CHAIN ALIAS | |
| | | PERSON-TO-PERSON | Feb. 11, 2016 |
| | | PAYMENTS | |
| 6988US1.014033.2607 | | SYSTEM FOR | Concurrently |
| | | CONVERSION OF AN | Herewith |
| | | INSTRUMENT FROM A | |
| | | NON-SECURED | |
| | | INSTRUMENT TO A | |
| | | SECURED INSTRUMENT | |
| | | IN A PROCESS DATA | |
| | | NETWORK | |
| 6989US1.014033.2608 | | SYSTEM FOR EXTERNAL | Concurrently |
| | | SECURE ACCESS TO | Herewith |
| | | PROCESS DATA | |
| | | NETWORK | |
| 6990US1.014033.2609 | | SYSTEM FOR PROVIDING | Concurrently |
| | | LEVELS OF SECURITY | Herewith |
| | | ACCESS TO A PROCESS | |
| | | DATA NETWORK | |
| 6991USP1.014033.2610 | 62/293,585 | SYSTEM FOR SECURE | Feb. 10, 2016 |
| | | ROUTING OF DATA TO | |
| | | VARIOUS NETWORKS | |
| | | FROM A PROCESS DATA | |
| | | NETWORK | |
| 6992USP1.014033.2611 | 62/293,620 | SYSTEM FOR | Feb. 10, 2016 |
| | | CENTRALIZED CONTROL | |
| | | OF SECURE ACCESS TO | |
| | | PROCESS DATA | |
| | | NETWORK | |
| 6993US1.014033.2612 | | SYSTEM FOR CONTROL | Concurrently |
| | | OF SECURE ACCESS AND | Herewith |
| | | COMMUNICATION WITH | |
| | | DIFFERENT PROCESS | |
| | | DATA NETWORKS WITH | |
| | | SEPARATE SECURITY | |
| | | FEATURES | |
| 6994US1.014033.2613 | | SYSTEM FOR CONTROL | Concurrently |
| | | OF DEVICE IDENTITY | Herewith |
| | | AND USAGE IN A | |
| | | PROCESS DATA | |
| | | NETWORK | |
| 6996US1.014033.2615 | | SYSTEM FOR | Concurrently |
| | | ESTABLISHING SECURE | Herewith |
| | | ACCESS FOR USERS IN A | |
| | | PROCESS DATA | |
| | | NETWORK | |
| 6997US1.014033.2616 | | SYSTEM FOR ALLOWING | Concurrently |
| | | EXTERNAL VALIDATION | Herewith |
| | | OF DATA IN A PROCESS | |
| | | DATA NETWORK | |
| 6998US1.014033.2719 | | SYSTEM FOR | Concurrently |
| | | CONVERSION OF AN | Herewith |
| | | INSTRUMENT FROM A | |
| | | NON-SECURED | |
| | | INSTRUMENT TO A | |
| | | SECURED INSTRUMENT | |
| | | IN A PROCESS DATA | |
| | | NETWORK | |
| 6998USP1.014033.2617 | 62/287,293 | SYSTEM FOR | Jan. 26, 2016 |
| | | CONVERSION OF AN | |
| | | INSTRUMENT FROM A | |
| | | NON-SECURED | |
| | | INSTRUMENT TO A | |
| | | SECURED INSTRUMENT | |
| | | IN A PROCESS DATA | |
| | | NETWORK | |
| 6999USP1.014033.2618 | 62/287,301 | SYSTEM FOR TRACKING | Jan. 26, 2016 |
| | | AND VALIDATION OF | |
| | | MULTIPLE INSTANCES | |
| | | OF AN ENTITY IN A | |
| | | PROCESS DATA | |
| | | NETWORK | |
| 7000US1.014033.2721 | | SYSTEM FOR TRACKING | Concurrently |
| | | AND VALIDATION OF AN | Herewith |
| | | ENTITY IN A PROCESS | |
| | | DATA NETWORK | |
| 7000USP1.014033.2619 | 62/287,298 | SYSTEM FOR TRACKING | Jan. 26, 2016 |
| | | AND VALIDATION OF AN | |
| | | ENTITY IN A PROCESS | |
| | | DATA NETWORK | |
| 7001US1.014033.2620 | | SYSTEM FOR ROUTING | Concurrently |
| | | OF PROCESS | Herewith |
| | | AUTHORIZATIONS AND | |
| | | SETTLEMENT TO A USER | |
| | | IN A PROCESS DATA | |
| | | NETWORK | |
| 7002US1.014033.2621 | | SYSTEM FOR ROUTING | Concurrently |
| | | OF PROCESS | Herewith |
| | | AUTHORIZATION AND | |
| | | SETTLEMENT TO A USER | |
| | | IN PROCESS DATA | |
| | | NETWORK BASED ON | |
| | | SPECIFIED PARAMETERS | |
| 7003US1.014033.2622 | | SYSTEM FOR GRANT OF | Concurrently |
| | | USER ACCESS AND DATA | Herewith |
| | | USAGE IN A PROCESS | |
| | | DATA NETWORK | |
| 7033US1.014033.2638 | | SYSTEM FOR | Concurrently |
| | | IMPLEMENTING A | Herewith |
| | | DISTRIBUTED LEDGER | |
| | | ACROSS MULTIPLE | |
| | | NETWORK NODES | |
| 7038US1.014033.2643 | | SYSTEM FOR EXTERNAL | Concurrently |
| | | VALIDATION OF | Herewith |
| | | PRIVATE-TO-PUBLIC | |
| | | TRANSITION PROTOCOLS | |
| 7039US1.014033.2644 | | SYSTEM FOR EXTERNAL | Concurrently |
| | | VALIDATION OF | Herewith |
| | | DISTRIBUTED RESOURCE | |
| | | STATUS | |
| 7040US1.014033.2645 | | SYSTEM FOR TRACKING | Concurrently |
| | | TRANSFER OF | Herewith |
| | | RESOURCES IN A | |
| | | PROCESS DATA | |
| | | NETWORK | |
| 7041US1.014033.2651 | | SYSTEM FOR MANAGING | Concurrently |
| | | SERIALIZABILITY OF | Herewith |
| | | RESOURCE TRANSFERS | |
| | | IN A PROCESS DATA | |
| | | NETWORK | |
| 7042US1.014033.2640 | | SYSTEM TO ENABLE | Concurrently |
| | | CONTACTLESS ACCESS | Herewith |
| | | TO A TRANSACTION | |
| | | TERMINAL USING A | |
| | | PROCESS DATA NETWORK | |

What is claimed is:

1. A system for tracking and validating multiple instance of a user, the system comprising:
a memory device with computer-readable program code stored thereon;
a communication device;
a processing device operatively coupled to the memory device and the communication device, wherein the processing device is configured to execute the computer-readable program code to:
receive an end-point identification for the user at one or more nodes of the block chain distributed network;
update a distributed ledger with the end-point identification via transmission of data from the one or more nodes to the distributed ledger associated with the block chain distributed network;
receive one or more identifications for the user at the one or more nodes of the block chain distributed network, wherein the received one or more identifications are tracked and time stamped at each identification use;
link the one or more identifications for the user to the end-point identification to generate an ongoing record of user identifications;
create a validity window for each of the one or more identifications for the user, wherein the validity window is a time frame after the last identification use that each of the one or more identifications are valid for identity authorization for the user;
receive a transaction record comprising one of the one or more identifications for the user;
confirm the one of the one or more identifications for the user is received within the validity window for the one of the one or more identifications; and
communicate the confirmation and the end-point identification associated with the user of the one of the one or more identifications.

2. The system of claim 1, further comprises:
confirming the one of the one or more identifications for the user is not within the validity window for the one of the one or more identifications; and
communicating, via a communication like with a user device, to the user the confirmation, wherein the communication allows the user to present an alternative identification for a transaction.

3. The system of claim 1, wherein the one or more nodes of the block chain distributed network is integrated into a third party system and coded to identify and transmit to the distributed ledger the one or more identifications used by the user for identity authorization for a transaction.

4. The system of claim 1, wherein the end-point identification comprises a tax identification, social security identification, or name given at an inception of the user.

5. The system of claim 1, wherein the end-point identification has an unlimited duration validity window.

6. The system of claim 1, wherein a duration of the validity window time frame is generated based on a type of identification being used, a duration of time the identification being used has been in existence, and required steps for user manipulation of the identification.

7. The system of claim 1, wherein the user is an individual or an entity and the one or more identifications of the user further comprise a trade name, alias, internet handle, or username associated with the user.

8. The system of claim 1, wherein receiving the transaction record comprising one of the one or more identifications for the user further comprises matching the received one of the one or more identifications to a previously stored one or more identifications in the distributed ledger.

9. A computer program product for tracking and validating multiple instance of a user, the computer program product comprising at least one non-transitory computer-readable medium having computer-readable program code portions embodied therein, the computer-readable program code portions comprising:
an executable portion configured for receiving an end-point identification for the user at one or more nodes of the block chain distributed network;
an executable portion configured for updating a distributed ledger with the end-point identification via transmission of data from the one or more nodes to the distributed ledger associated with the block chain distributed network;
an executable portion configured for receiving one or more identifications for the user at the one or more nodes of the block chain distributed network, wherein the received one or more identifications are tracked and time stamped at each identification use;
an executable portion configured for linking the one or more identifications for the user to the end-point identification to generate an ongoing record of user identifications;
an executable portion configured for creating a validity window for each of the one or more identifications for the user, wherein the validity window is a time frame after the last identification use that each of the one or more identifications are valid for identity authorization for the user;
an executable portion configured for receiving a transaction record comprising one of the one or more identifications for the user;
an executable portion configured for confirming the one of the one or more identifications for the user is received within the validity window for the one of the one or more identifications; and
an executable portion configured for communicating the confirmation and the end-point identification associated with the user of the one of the one or more identifications.

10. The computer program product of claim 9, further comprises:
an executable portion configured for confirming the one of the one or more identifications for the user is not within the validity window for the one of the one or more identifications; and
an executable portion configured for communicating, via a communication like with a user device, to the user the confirmation, wherein the communication allows the user to present an alternative identification for a transaction.

11. The computer program product of claim 9, wherein the one or more nodes of the block chain distributed network is integrated into a third party system and coded to identify and transmit to the distributed ledger the one or more identifications used by the user for identity authorization for a transaction.

12. The computer program product of claim 9, wherein the end-point identification comprises a tax identification, social security identification, or name given at an inception of the user.

13. The computer program product of claim 9, wherein the end-point identification has an unlimited duration validity window.

14. The computer program product of claim 9, wherein a duration of the validity window time frame is generated based on a type of identification being used, a duration of time the identification being used has been in existence, and required steps for user manipulation of the identification.

15. The computer program product of claim 9, wherein the user is an individual or an entity and the one or more identifications of the user further comprise a trade name, alias, internet handle, or username associated with the user.

16. The computer program product of claim 9, wherein receiving the transaction record comprising one of the one or more identifications for the user further comprises matching the received one of the one or more identifications to a previously stored one or more identifications in the distributed ledger.

17. A computer-implemented method for tracking and validating multiple instance of a user, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving an end-point identification for the user at one or more nodes of the block chain distributed network;
updating a distributed ledger with the end-point identification via transmission of data from the one or more nodes to the distributed ledger associated with the block chain distributed network;
receiving one or more identifications for the user at the one or more nodes of the block chain distributed network, wherein the received one or more identifications are tracked and time stamped at each identification use;
linking the one or more identifications for the user to the end-point identification to generate an ongoing record of user identifications;
creating a validity window for each of the one or more identifications for the user, wherein the validity window is a time frame after the last identification use that each of the one or more identifications are valid for identity authorization for the user;
receiving a transaction record comprising one of the one or more identifications for the user;
confirming the one of the one or more identifications for the user is received within the validity window for the one of the one or more identifications; and
communicating the confirmation and the end-point identification associated with the user of the one of the one or more identifications.

18. The computer-implemented method of claim 17, further comprises:
confirming the one of the one or more identifications for the user is not within the validity window for the one of the one or more identifications; and
communicating, via a communication like with a user device, to the user the confirmation, wherein the communication allows the user to present an alternative identification for a transaction.

19. The computer-implemented method of claim 17, wherein the one or more nodes of the block chain distributed network is integrated into a third party system and coded to identify and transmit to the distributed ledger the one or more identifications used by the user for identity authorization for a transaction.

20. The computer-implemented method of claim 17, wherein the end-point identification comprises a tax identification, social security identification, or name given at an inception of the user and wherein the end-point identification has an unlimited duration validity window.
